(19) United States
(12) Patent Application Publication
(10) Pub. No.: US 2025/0042291 A1
(43) Pub. Date: Feb. 6, 2025

(54) CHARGING CONTROL DEVICE AND CHARGING CONTROL METHOD

(71) Applicant: Toyota Jidosha Kabushiki Kaisha, Toyota-shi (JP)

(72) Inventor: Kazuki IWAMA, Nisshin-shi (JP)

(73) Assignee: Toyota Jidosha Kabushiki Kaisha, Toyota-shi (JP)

(21) Appl. No.: 18/782,777

(22) Filed: Jul. 24, 2024

(30) Foreign Application Priority Data
Jul. 31, 2023 (JP) 2023-124649

(51) Int. Cl. B60L 53/66; B60L 53/62

(52) U.S. Cl. CPC B60L 53/66; B60L 53/62

(57) ABSTRACT

An ECU controls charging of a battery. The ECU includes a CPU and a communication unit that communicates with a charger. The CPU specifies a limit value Win of charging power after a predetermined period. The CPU determines whether electric power corresponding to a current charging command value for the charger exceeds limit value Win. When determining that the electric power corresponding to the charging command value exceeds limit value Win, the CPU limits the charging command value so that the electric power corresponding to the charging command value does not exceed limit value Win until the predetermined period elapses.

10 The CPU controls the communication unit to transmit the limited charging command value to the charger. Accordingly, it is possible to limit the charging command value only when necessary and not to limit the charging command value unless necessary.

### CROSS REFERENCE TO RELATED APPLICATIONS

This nonprovisional application is based on Japanese Patent Application No. 2023-124649 filed on Jul. 31, 2023 with the Japan Patent Office, the entire contents of which are hereby incorporated by reference.

### BACKGROUND

### Field

The present disclosure relates to a charging control device and a charging control method, and more particularly, to a charging control device that controls charging of a power storage device and a charging control method using the charging control device.

### Description of the Background Art

Conventionally, in order to prevent a charging power limit value from being exceeded when a power storage device is charged, a margin is provided with respect to a predicted value of charging power (see, for example, Japanese Patent Laying-Open No. 2020-182262).

### SUMMARY

Various chargers may be used for charging. A margin provided so as to adapt to various chargers results in a problem that the charging time taken for charging becomes longer.

The present disclosure is made to solve the above-described problem, and an object of the present disclosure is to provide a charging control device and a charging control method that make it possible to prevent the charging time from becoming longer.

A charging control device according to the present disclosure controls charging of a power storage device. The charging control device includes a processor and a communication unit that communicates with a charger. The processor specifies a limit value of charging power after a predetermined period. The processor determines whether electric power corresponding to a current charging command value for the charger exceeds the limit value. The processor limits the charging command value so that the electric power corresponding to the charging command value does not exceed the limit value until the predetermined period elapses, when determining that the electric power corresponding to the charging command value exceeds the limit value. The processor controls the communication unit to transmit the limited charging command value to the charger.

In accordance with such a configuration, when it is determined that electric power corresponding to the current charging command value for the charger exceeds the limit value of the charging power after the predetermined period, the charging command value that is limited so that the electric power corresponding to the charging command value does not exceed the limit value until the predetermined period elapses is transmitted to the charger. It is therefore possible to limit the charging command value only when necessary and not to limit the charging command value unless necessary. Accordingly, the charging control device that makes it possible to prevent the charging time from becoming longer can be provided.

The processor may limit the charging command value by lowering the charging command value in a predetermined manner. In accordance with such a configuration, the charging command value can appropriately be limited when necessary.

The processor may maintain the charging command value when determining that the electric power corresponding to the charging command value does not exceed the limit value. The processor may control the communication unit to transmit the maintained charging command value to the charger. In accordance with such a configuration, it is possible not to limit the charging command value unless necessary.

The processor may calculate an increase in the predetermined period in an amount of charge of the power storage device. The processor may specify the limit value using the calculated increase in the amount of charge. In accordance with such a configuration, the limit value of the charging power after the predetermined period can be specified appropriately.

According to another aspect of the present disclosure, a charging control method is a charging control method for controlling charging of a power storage device by a charging control device. The charging control device includes a processor, and a communication unit that communicates with a charger. The charging control method includes: specifying, by the processor, a limit value of charging power after a predetermined period; determining, by the processor, whether electric power corresponding to a current charging command value for the charger exceeds the limit value; limiting, by the processor, the charging command value so that the electric power corresponding to the charging command value does not exceed the limit value until the predetermined period elapses, when determining that the electric power corresponding to the charging command value exceeds the limit value; and controlling, by the processor, the communication unit to transmit the limited charging command value to the charger.

In accordance with such a configuration, it is possible to provide the charging control method that makes it possible to prevent the charging time from becoming longer.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a diagram schematically showing an overall configuration of a charging system according to this embodiment.

FIG. 2 is a diagram illustrating the configuration of the charging system in more detail.

FIG. 3 is a flowchart showing a flow of a charging control process in this embodiment.

FIG. 4 is a flowchart illustrating a flow of a charging control process when a margin is provided.

### DESCRIPTION OF THE PREFERRED EMBODIMENTS

Hereinafter, embodiments of the present disclosure will be described in detail with reference to the drawings. In the drawings, the same or corresponding parts are denoted by the same reference numerals, and the description thereof will not be repeated.

### <Charging System Configuration>

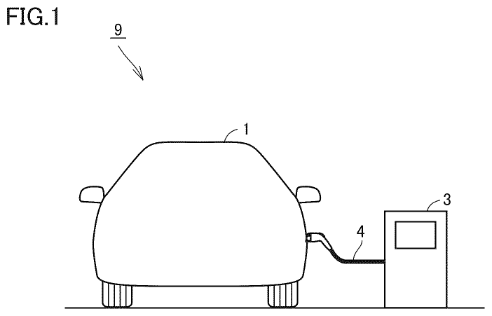

FIG. 1 is a diagram schematically showing an overall configuration of a charging system 9 according to this embodiment. Referring to FIG. 1, a charging system 9 includes a vehicle 1 of a user, a charger 3, and a charging cable 4 extending from the charger 3.

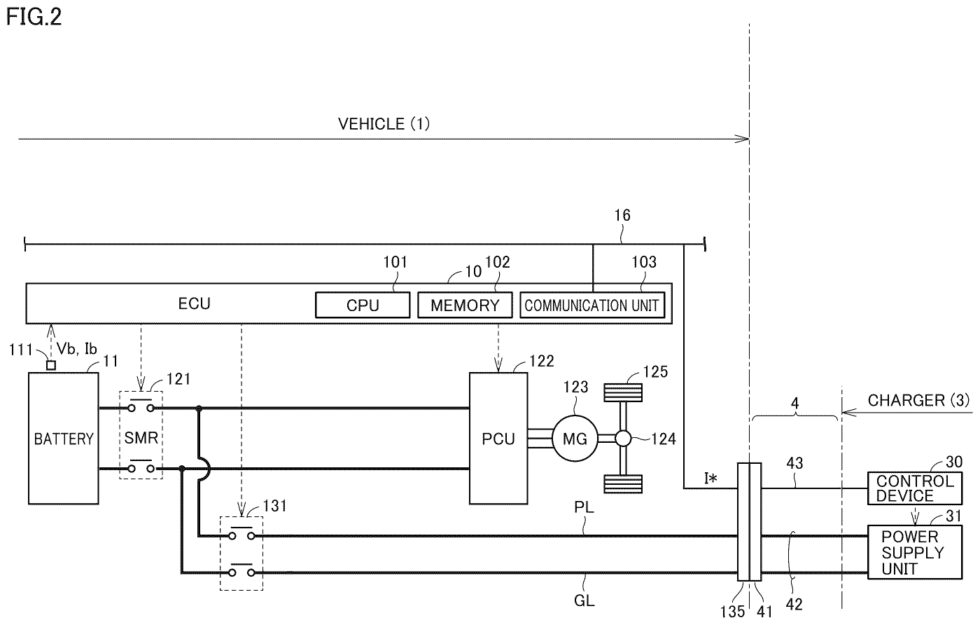

The vehicle 1 is, for example, a battery electric vehicle on which a battery 11 (see FIG. 2 described later) is mounted. The vehicle 1 is configured to be capable of “external charging” in which the battery 11 is charged with electric power supplied from the charger 3 in a state in which the vehicle 1 and the charger 3 are electrically connected to each other by the charging cable 4. The vehicle 1 may be a plug-in hybrid electric vehicle or a fuel cell electric vehicle as long as external charging is possible.

The charger 3 is installed in, for example, a public charging stand (also referred to as a charging spot or a charging station). The charger 3 converts an AC power supply (for example, a three-phase 200V power supply) supplied from a commercial power supply into DC power, and supplies the DC power to the vehicle 1.

In this embodiment, the charger 3 is a fast chargeable charger. Further, for the charger 3 of this embodiment, a nominal minimum power corresponding to a nominal minimum current that can be output is predetermined. It is assumed that this nominal minimum power is stored in the charger 3. The charger 3 transmits the minimum power to the vehicle 1 at the start of charging the battery 11 of the vehicle 1.

FIG. 2 is a diagram illustrating the configuration of the charging system 9 in more detail. Referring to FIGS. 1 and 2, vehicle 1 includes the battery 11, a monitoring unit 111, a system main relay (SMR) 121, a power control unit (PCU) 122, a motor generator (MG) 123, a power transmission gear 124, drive wheels 125, and ECU (Electronic Control Unit) 10.

The battery 11 is a rechargeable power storage device and includes a secondary battery such as a lithium-ion secondary battery or a nickel-metal hydride battery. The battery 11 supplies electric power for generating the travel driving force of the vehicle 1 to the PCU 122. The battery 11 is charged with electric power generated by regenerative braking of the motor generator 123, or is charged with electric power supplied from the charger 3. Instead of the battery 11, a capacitor such as an electric double layer capacitor may be employed.

The monitoring unit 111 monitors the state of the battery 11. Although not shown, the monitoring unit 111 includes a voltage sensor, a current sensor, and a temperature sensor. The voltage sensor detects the voltage Vb of the battery 11. The current sensor detects a current Ib input to and output from the battery 11. The temperature sensor detects the temperature of the battery 11. Each sensor outputs the detection result to the ECU 10. The ECU 10 can calculate the SOC (State Of Charge) of the battery 11 based on the detection results of the sensors.

The SMR 121 is electrically connected between the battery 11 and the PCU 122. Closing/opening of the SMR 121 is controlled in accordance with a command from the ECU 10.

The PCU 122 is a power conversion device that performs power conversion between the battery 11 and the motor generator 123 in accordance with a command from the ECU 10. The PCU 122 is configured to include an inverter that receives electric power from the battery 11 to drive the motor generator 123, a converter (both not shown) that adjusts the level of a DC voltage supplied to the inverter, and the like.

The motor generator 123 is an AC motor. The motor generator 123 is driven by an inverter included in the PCU 122 to rotate a drive shaft. The torque output by the motor generator 123 is transmitted to the drive wheels 125 via the power transmission gear 124, whereby the vehicle 1 travels. During braking of the vehicle, the motor generator 123 generates electric power by receiving the rotational force of the drive wheels 125. The electric power generated by the motor generator 123 is charged to the battery 11 through the PCU 122.

Vehicle 1 further includes charging relay 131, power lines PL and GL, and inlet 135 as a configuration for rapid charging.

The charger 3 includes a control device 30 and a power supply unit 31. Charging cable 4 includes power line 42, communication line 43, and connector 41.

When the battery 11 is rapidly charged, the connector 41 of the charging cable 4 is connected to the inlet 135. Then, power from the charger 3 is supplied to the vehicle 1 through the power line 42 in the charging cable 4, and is transmitted to the charging relay 131 through the power lines PL and GL.

The charging relay 131 and the SMR 121 are electrically connected between the battery 11 and the inlet 135. When the charging relay 131 is closed and the SMR 121 is closed, power can be transmitted between the inlet 135 and the battery 11.

In addition, in a state in which the vehicle 1 and the charger 3 are connected by the charging cable 4, the ECU 10 is configured to be capable of bidirectional communication with the control device 30 of the charger 3 via the communication line 43 in the charging cable 4 and the in-vehicle network 16.

The ECU 10 is configured to include CPU (Central Processing Unit) 101, a memory 102, a communication unit 103, an input/output port (not shown) for inputting and outputting various signals, and the like. The ECU 10 controls each device (such as the SMR 121, the PCU 122, and the charging relay 131) in the vehicle 1 so that the vehicle 1 is in a desired state.

When the battery 11 is charged with high electric power, the battery 11 fails or its life becomes short. Therefore, the limit value Win of the charging power corresponding to the SOC, the temperature, the voltage, and the current of the battery 11 is determined in advance for each battery 11.

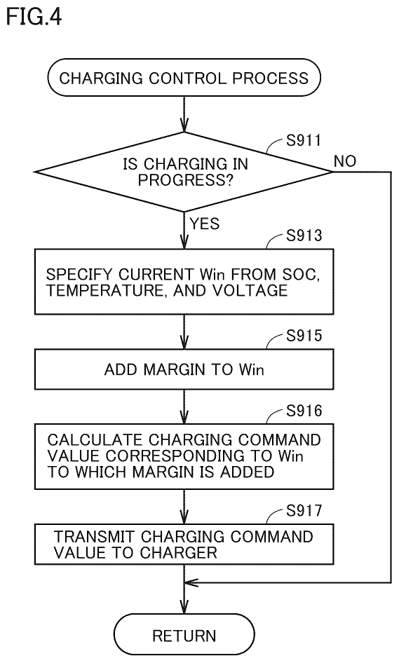

In order to prevent the charging power from exceeding the limit value Win when the battery 11 of the vehicle 1 is charged, a margin may be provided for the predicted value of the charging power. FIG. 4 is a flowchart illustrating a flow of a charging control process when a margin is provided. Referring to FIG. 4, specifically, the following can be considered. The CPU 101 of the ECU 10 determines whether or not charging is in progress (step S911). When it is determined that the battery 11 is being charged (YES in step S911), the current limit value Win is specified from the SOC (State Of Charge), the temperature, and the voltage of the battery 11 (step S913), a margin is added to the limit value Win (step S915), a charging command value corresponding to the Win to which the margin is added is calculated (step S916), and the communication unit 103 of the ECU 10 is controlled so as to transmit the calculated charging command value to the charger 3 (step S917).

During charging, various chargers 3 may be used. If the margin of step S915 is provided so as to cope with various chargers 3, the charging command value is lowered even when it is not necessary, and there is a problem that the charging time becomes long.

Therefore, the CPU 101 of the ECU 10 specifies the limit value Win of the charging power after a predetermined period. The CPU 101 determines whether or not the power corresponding to the current charging command value for the charger 3 exceeds the limit value Win. When determining that the power corresponding to the charging command value exceeds the limit value Win, the CPU 101 limits the charging command value so that the power corresponding to the charging command value does not exceed the limit value Win until the predetermined period elapses. The CPU 101 controls the communication unit 103 of the ECU 10 to transmit the limited charging command value to the charger 3.

Accordingly, when it is determined that the electric power corresponding to the current charging command value for the charger 3 exceeds the limit value Win of the charging power after the predetermined period, the charging command value limited so that the electric power corresponding to the charging command value does not exceed the limit value Win until the predetermined period elapses is transmitted to the charger 3. Therefore, it is possible to limit the charging command value only when necessary and not to limit the charging command value unless necessary. As a result, the charging time can be prevented from being prolonged.

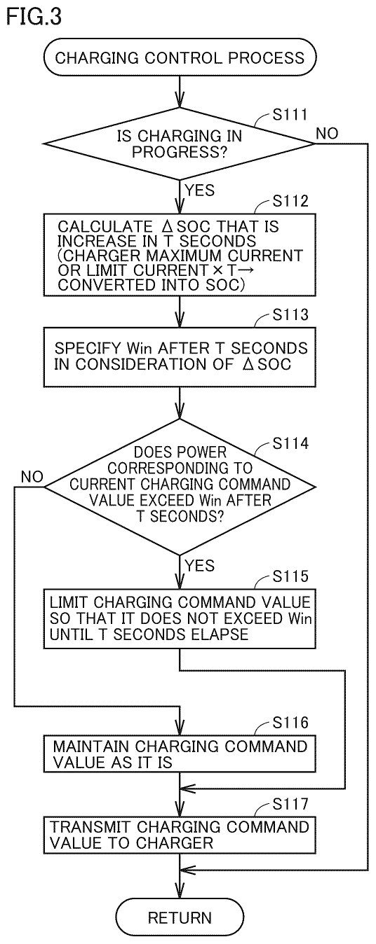

FIG. 3 is a flowchart showing a flow of a charging control process in this embodiment. Referring to FIG. 3, the charging control process is called and executed by the CPU 101 of the ECU 10 at predetermined intervals from a higher-level process.

The CPU 101 of the ECU 10 determines whether or not charging is in progress (step S111). If it is determined that the battery is not being charged (NO in step $111), the CPU 101 returns the process to be executed to the higher-level process of the calling source of the charging control process.

On the other hand, when it is determined that the battery is being charged (YES in step S111), the CPU 101 calculates ASOC which is an increase in the SOC in a predetermined period (for example, T seconds) (step S112). The ASOC can be calculated by converting the maximum current that can be output by the charger 3 or a value obtained by multiplying the limit current by T when the charging power is limited, into the SOC.

The actual current value of the charging command value is not necessarily equal to the maximum current or the limit current. For example, the actual current value of the charging command value varies depending on the charging method. In constant current (CC) charging, charging is performed at a constant current value until a termination condition (normal voltage, charging power amount) is reached. In

CCCV (Constant Current, Constant Voltage) charging, charging is performed by CC charging until a predetermined voltage is reached, and when the predetermined voltage is reached, charging is performed while keeping the predetermined voltage by reducing the charging current. As described above, the actual current value of the charging command value varies depending on the charging method and the charging condition. A current value corresponding to the charging method is calculated. The power corresponding to the calculated current value is compared with the current charging power limit value Win. When the power corresponding to the current value does not exceed the limit value Win, the calculated current value is set as the charging command value. When the power corresponding to the current value exceeds the limit value Win, the current value limited so as not to exceed the limit value Win is set as the charging command value.

Next, the CPU 101 specifies the limit value Win of the charging power after the predetermined period (for example, T seconds) in consideration of the ASOC calculated in step S112 (step S113). For example, the CPU 101 calculates an increase in a predetermined period in the amount of charge (for example, SOC) of the battery 11. The CPU 101 specifies the limit value Win of the charging power by using the calculated increase in the amount of charge. Then, the CPU 101 determines whether or not the power corresponding to the current charging command value exceeds the limit value Win of the charging power after the predetermined period (for example, T seconds) (step S114).

When it is determined that the power corresponding to the current charging command value exceeds the limit value Win of the charging power after the predetermined period (YES in step S114), the CPU 101 limits the charging command value so that the charging command value does not exceed the limit value Win of the charging power until the predetermined period (for example, T seconds) elapses (step S115). The charging command value is limited by being lowered in a predetermined manner. The predetermined mode may be, for example, a mode of decreasing by a predetermined ratio, a mode of decreasing by a predetermined value, a mode of decreasing proportionally, or a mode of decreasing exponentially.

On the other hand, when it is determined that the power corresponding to the current charging command value does not exceed the limit value Win of the charging power after the predetermined period (NO in step S114), the CPU 101 maintains the charging command value as it is (step S116).

Then, the CPU 101 transmits the charging command value determined in step S115 or step S116 to the charger 3 (step S117). After that, the CPU 101 returns the processing to be executed to the higher-level processing of the calling source of the charging control process.

The control device 30 of the charger 3 receives the charging command value. When the current value of the charging command value does not exceed the maximum current of the charger 3, the power supply unit 31 is controlled to supply electric power of the current value of the charging command value to the vehicle 1. When the current value of the charging command value exceeds the maximum current of the charger 3, the power supply unit 31 is controlled to supply power corresponding to the maximum current to the vehicle 1.

### [Modifications]

(1) In the above-described embodiment, the charging command value for the charger 3 is the current value. However, the present disclosure is not limited thereto, and the charging command value for the charger 3 may be a power value.

(2) The disclosure described above can be considered as a disclosure of a charging control device such as the ECU 10 that controls charging of the battery 11. The above disclosure can be considered as a disclosure of a charging control method by the charging control device or a charging control program for executing the processing shown in FIG. 3.

### [SUMMARY]

(1) As shown in FIGS. 1 and 2, the ECU 10 controls charging of the battery 11. As illustrated in FIG. 2, the ECU 10 includes a CPU 101 and a communication unit 103 that communicates with the charger 3. As shown in FIG. 3, the CPU 101 specifies the limit value Win of the charging power after the predetermined period (for example, T seconds) (for example, step S113). The CPU 101 determines whether or not the power corresponding to the current charging command value for the charger 3 exceeds the limit value Win (for example, step S114). When determining that the power corresponding to the charging command value exceeds the limit value Win, the CPU 101 limits the charging command value so that the power corresponding to the charging command value does not exceed the limit value Win until the predetermined period elapses (for example, step S115). The CPU 101 controls the communication unit 103 to transmit the limited charging command value to the charger 3 (step S117, for example).

Accordingly, when it is determined that the electric power corresponding to the current charging command value for the charger 3 exceeds the limit value Win of the charging power after the predetermined period, the charging command value limited so that the electric power corresponding to the charging command value does not exceed the limit value Win until the predetermined period elapses is transmitted to the charger 3. Therefore, the charging command value can be limited only when necessary. The charging command value can be prevented from being limited unless necessary. As a result, the charging time can be prevented from being prolonged.

(2) As shown in FIG. 3, the CPU 101 may limit the charging command value by lowering it in a predetermined manner (for example, step S115). Accordingly, the charging command value can be appropriately limited when necessary.

(3) As shown in FIG. 3, when determining that the power corresponding to the charging command value does not exceed the limit value Win, the CPU 101 may maintain the charging command value (for example, step S116). The CPU 101 may control the communication unit 103 to transmit the maintained charging command value to the charger 3 (e.g., step S117). As a result, the charging command value can be prevented from being restricted unless necessary.

(4) As shown in FIG. 3, the CPU 101 may calculate an increase in the predetermined period in the amount of charge (e.g., SOC) of the battery 11 (e.g., step

S112). The CPU 101 may specify the limit value Win using the calculated increase in the amount of charge (for example, step S113). Accordingly, the limit value Win of the charging power after the predetermined period can be appropriately specified.

Although the present disclosure has been described and illustrated in detail, it is clearly understood that the same is by way of illustration and example only and is not to be taken by way of limitation, the scope of the present disclosure being interpreted by the terms of the appended claims.

What is claimed is:

1. A charging control device that controls charging of a power storage device, the charging control device comprising:
a processor; and
a communication unit that communicates with a charger, wherein the processor
specifies a limit value of charging power after a predetermined period,
determines whether electric power corresponding to a current charging command value for the charger exceeds the limit value,
limits the charging command value so that the electric power corresponding to the charging command value does not exceed the limit value until the predetermined period elapses, when determining that the electric power corresponding to the charging command value exceeds the limit value, and
controls the communication unit to transmit the limited charging command value to the charger.

2. The charging control device according to claim 1, wherein the processor limits the charging command value by lowering the charging command value in a predetermined manner.

3. The charging control device according to claim 1, wherein
the processor
maintains the charging command value when determining that the electric power corresponding to the charging command value does not exceed the limit value, and
controls the communication unit to transmit the maintained charging command value to the charger.

4. The charging control device according to claim 1, wherein
the processor
calculates an increase in the predetermined period in an amount of charge of the power storage device, and
specifies the limit value using the calculated increase in the amount of charge.

5. A charging control method for controlling charging of a power storage device by a charging control device,
the charging control device comprising:
a processor; and
a communication unit that communicates with a charger, the charging control method comprising:
specifying, by the processor, a limit value of charging power after a predetermined period;
determining, by the processor, whether electric power corresponding to a current charging command value for the charger exceeds the limit value;
limiting, by the processor, the charging command value so that the electric power corresponding to the charging command value does not exceed the limit value until the predetermined period elapses, when determining that the electric power corresponding to the charging command value exceeds the limit value; and
controlling, by the processor, the communication unit to transmit the limited charging command value to the charger.
